(19) United States
(12) Patent Application Publication
(10) Pub. No.: US 2018/0109656 A1
(43) Pub. Date: Apr. 19, 2018

(54) SERVER AND METHOD FOR MANAGING POSITION CHANGE

(71) Applicant: Spacosa Corporation, Seoul (KR)

(72) Inventors: Wooju CHO, Suwon-si (KR); Wonki KIM, Gwangju-si (KR); Youngjune KIM, Seoul (KR)

(21) Appl. No.: 15/333,957

(22) Filed: Oct. 25, 2016

(30) Foreign Application Priority Data
Oct. 13, 2016 (KR) 10-2016-0132853

(51) Int. Cl. H04L 29/08; H04L 29/06; G06F 17/30

(52) U.S. Cl. CPC H04L 69/324; H04L 67/10; G06F 17/30312; G06F 17/30424; H04L 69/22

(57) ABSTRACT

Provided is a server for managing a position change in real time. The server includes a log receiver configured to store log data in order of reception, a main table configured to sort and store the log data using a certain sorting method, a sub-table configured to temporarily store the log data, and a data transmitter configured to sequentially read and process a log stored in the main table or the sub-table in real time and transmit the log to a remote database in real time, wherein the server determines whether data received when a transaction is performed is initially input data, stores position information extracted from the data in a predetermined additional area of the main table when the data is the initially input data, and stores the position information extracted from the data in a designated area allocated to a recipient of the data when the data is not the initially input data, and the data transmitter analyzes the data stored in the main table, converts the data into a packet using a result of the analysis, and transmits the packet.

### CROSS-REFERENCE TO RELATED APPLICATIONS

This application claims the benefit of priority of Korean Patent Application No. 10-2016-0132853, filed on Oct. 13, 2016, in the Korean Intellectual Property Office, the disclosure of which is incorporated herein in its entirety by reference.

### BACKGROUND

### 1. Field

One or more embodiments relate to a server and method for managing a position change.

### 2. Description of the Related Art

So far, data obtained by collecting positions of users in real time is stored and managed without change.

### SUMMARY

One or more embodiments include a server and method for managing a position change, which may reduce resources since data determined as meaningless data is not stored even though log data is received in real time.

One or more embodiments include a server and method for managing a position change, which may generate a position change history of a plurality of terminals with a smaller amount of data since a packet is transmitted to an external database only when the position change is detected.

One or more embodiments include a server and method for managing a position change, which may protect log data stored in different divided areas since the log data is divisionally stored in a predetermined amount of units.

Additional aspects will be set forth in part in the description which follows and, in part, will be apparent from the description, or may be learned by practice of the presented embodiments.

According to one or more embodiments, a server for managing a position change in real time includes: a log receiver configured to store log data in order of reception; a main table configured to sort and store the log data using a certain sorting method; a sub-table configured to temporarily store the log data; and a data transmitter configured to sequentially read and process a log stored in the main table or the sub-table in real time and transmit the log to a remote database in real time, wherein: the server determines whether data received when a transaction is performed is initially input data, stores position information extracted from the data in a predetermined additional area of the main table when the data is the initially input data, and stores the position information extracted from the data in a designated area allocated to a recipient of the data when the data is not the initially input data; and the data transmitter analyzes the data stored in the main table, converts the data into a packet using a result of the analysis, and transmits the packet.

The data transmitter may read data stored in the main table and may determine whether the position information extracted from the data is different from previous position information.

The data transmitter may read the data stored in the main table, and may move the data to the sub-table and may convert data stored in the sub-table into a packet only when the extracted position information is different from the previous position information.

The data transmitter may determine whether there is duplication in the data stored in the main table and may remove duplicated data.

The data transmitter may read data stored in the main table, and may additionally search for peripheral information corresponding to the data and may correct the position information using the peripheral information when the position information extracted from the data does not satisfy a predetermined condition.

The data transmitter may analyze the data to acquire a start time point and an end time point, may generate a header including (from the start time point, to the end time point), and may generate a packet by adding the header to the data.

According to one or more embodiments, a method of managing a position change in real time includes: storing, by a log receiver, log data in order of reception; sorting and storing, by a server, the log data in a main table using a certain sorting method; determining whether data received when a transaction is performed is initially input data and storing position information extracted from the data in a predetermined additional area of the main table when the data is the initially input data; and sequentially reading and processing, by a data transmitter, a log stored in the main table or the sub-table and transmitting the log to a remote database in real time.

The transmitting may include using, by the data transmitter, a result of analyzing the data stored in the main table to convert the data into a packet and transmit the packet.

The transmitting may further include reading, by the data transmitter, the data stored in the main table and determining whether the position information extracted from the data is different from previous position information.

The transmitting may further include reading the data stored in the main table, and moving the data to the sub-table and converting data stored in the sub-table into a packet only when the acquired position information is different from the previous position information.

The transmitting may include determining whether there is duplication in the data stored in the main table and removing duplicated data.

The transmitting may further include reading the data stored in the main table, and additionally searching for peripheral information corresponding to the data and correcting the position information using the peripheral information when the position information extracted from the data does not satisfy a predetermined condition.

The transmitting may include analyzing the data to acquire a start time point and an end time point, generating a header including (from the start time point, to the end time point), and generating a packet by adding the header to the data.

A computer program according to an embodiment of the present invention may be stored in a medium in order to execute any one of methods of managing a position change according to an embodiment of the present invention.

In addition, other methods and devices for implementing the present invention and a computer-readable recording medium for recording a computer program for executing the methods are further provided.

The above and other aspects, features, and advantages of the present disclosure will become apparent from the following description taken in conjunction with the accompanying drawings, claims, and detailed description.

### BRIEF DESCRIPTION OF THE DRAWINGS

These and/or other aspects will become apparent and more readily appreciated from the following description of the embodiments, taken in conjunction with the accompanying drawings in which:

FIG. 1 shows a block diagram of a server according to an embodiment of the present invention;

FIG. 2 is a diagram for describing an operation associated with a log receiver according to embodiments of the present invention;

FIGS. 3 and 4 are diagrams for describing examples of packets generated by a data transmitter; and

FIGS. 5A and 5B are diagrams for describing a process of determining whether a main table has duplication.

### DETAILED DESCRIPTION

Reference will now be made in detail to embodiments, examples of which are illustrated in the accompanying drawings, wherein like reference numerals refer to like elements throughout. In this regard, the present embodiments may have different forms and is not to be construed as being limited to the descriptions set forth herein. Accordingly, the embodiments are merely described below with reference to the figures to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

While the invention is susceptible to various modifications and alternative forms, exemplary embodiments thereof are shown by way of examples in the drawings and will herein be described in detail. Advantages and features of the present invention, and implementation methods thereof will be clarified through the following embodiments described with reference to the accompanying drawings. However, the present invention is not limited to the following embodiments and may be implemented in various forms.

Hereinafter, preferred embodiments of the present invention will be described in detail with reference to the accompanying drawings, and the same or similar elements are designated with the same numeral references regardless of the numerals in the drawings, and redundant descriptions thereof will be omitted.

It should be understood that although the terms “first,” “second,” etc. may be used herein to describe various components, these components are not limited by these terms. These terms are only used to distinguish one component from another.

As used herein, the singular forms “a,” “an,” and “the” are intended to include the plural forms as well, unless the context clearly indicates otherwise.

It should be further understood that the terms “comprises” and/or “comprising” used herein specify the presence of stated features or components, but do not preclude the presence or addition of one or more other features or components.

When a certain embodiment may be implemented differently, a specific process order may be performed differently from the described order. For example, two consecutively described processes may be performed at substantially the same time or performed in an order opposite to the described order.

In the following embodiments, a “circuit” may include, for example, a hard-wired circuit, a programmable circuit, a state machine circuit, firmware that stores instructions executable by a programmable circuit, and a combination thereof. An application may be implemented as code or instructions that are executable on a host processor or other programmable circuits. As used in an embodiment of the present invention, a module may be implemented as a circuit. The circuit may be implemented as an integrated circuit, such as an integrated circuit chip.

Furthermore, when one part is referred to as “comprising” (or “including” or “having”) other elements, it should be understood that it can comprise (or include or have) only those elements, or other elements as well as those elements unless specifically described otherwise. Moreover, terms such as “unit,” “part,” and “module” described in the specification refer to an element for performing at least one function or operation and may be implemented in hardware, software, or a combination of hardware and software.

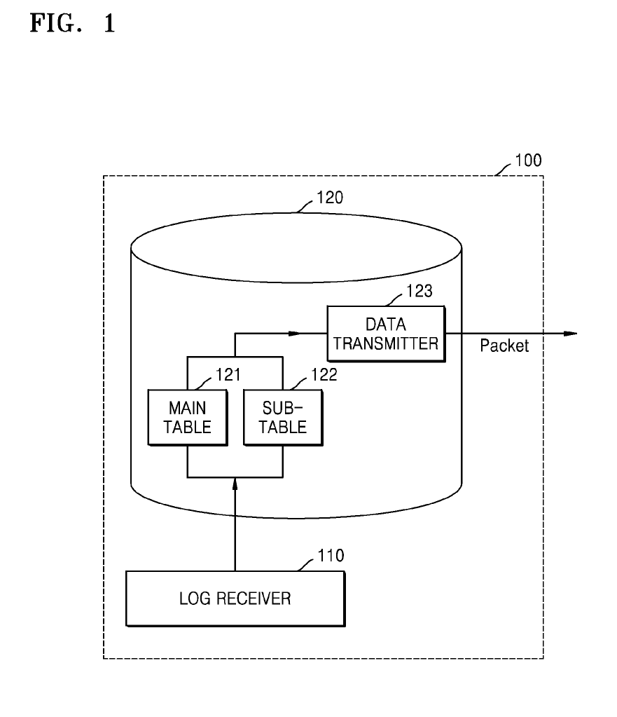

FIG. 1 shows a block diagram of a server according to an embodiment of the present invention.

As an embodiment of the present invention, a server 100 uses a main table 121 and a sub-table 122 in order to store and manage a position change of a user. The server 100 may be connected to user terminals through a communication network to receive log data from the user terminals. The server 100 may read and process the log data to generate a packet including meaningful data. The server 100 may transmit the packet to an external database. The server 100 may connect user terminals in which data is generated with the database, thus enabling collected data and generated data to be separately managed. The collected data and/or the generated data may be independently and separately managed in a recording medium. The server 100 may include an additional recording medium and/or storage medium for an increased capacity due to continuous collection and processing.

The server 100 may confirm position values of users through the collected log data and may classify the confirmed position values on the basis of time, user, and position. The server 100 may convert the acquired data into an integrated packet. The server 100 detects a change according to a classification criterion. That is, the server 100 may confirm a change in a position value of data classified for each user. The server 100 may confirm a change in time, a change in user, and the like of data classified for each position, and may convert the change into a packet that may inform of a position change. As a result, the server 100 may collect big data. Furthermore, the server 100 may acquire meaningful data from the big data. The server 100 may generate a packet including the acquired data in a predetermined format. The server 100 may process and provide the collected data according to requests from various devices.

The server 100 includes a log receiver 110 including a communication interface. The log receiver 110 may receive log data received through various communication networks. Here, the log data may be received from various applications or operating systems (OSes) mounted on or installed in a user terminal. The log data may include position information or state information of the user terminal in addition to an identifier (a phone number, a serial number, a communication interface identifier, etc.) assigned to the user terminal. In this case, the position information of the user terminal is acquired using a GPS module mounted on the user terminal, and is acquired using a number assigned to a communication network or a base station that communicates with the user terminal. The position information of the user terminal may be in the form of a code or a number assigned by a certain rule and may be interpreted according to a rule stored in the server 100.

The main table 121 may include a plurality of columns and may sort and store the received log data in a certain sorting method. The certain sorting method may be set according to a user, a caller's position, a received time, and the like, and may use various other factors. Also, the main table 121 may further include an index table for facilitating an understanding of the certain sorting method. That is, indices corresponding to the received log data may be generated, and the generated indices may be sorted by the sorting method and then stored and managed in a separate table. A data transmitter 123 or the log receiver 110 may access the log data stored in the main table 121 by using the index table.

The server 100 may further include a separate sub-table 122. Among information stored in the main table 121, the sub-table 122 may temporarily store data to be transmitted to the external database. The sub-table 122 may temporarily store data that satisfies a certain condition among data stored in the main table 121. For example, among the data stored in the main table 121, when at least one of a geographical position and a terminal state changes unlike data that has been previously received, the sub-table 122 may store the changed data. The sub-table 122 is managed separately from the log receiver 110 and the main table 121. Thus, the sub-table 122 is not affected by the log receiver 110 and the main table 121, and operates independently. Other than while the log data is received, that is, when processors do not make the server 100 busy, the data stored in the sub-table 122 may be converted into a packet and transmitted to the external database.

For example, the server 100 may sort the main table 121 and/or the sub-table 122 in consideration of a receiving terminal. In this case, the server 100 may allocate records included in the main table 121 for each user. The server 100 may determine whether data received when a transaction is performed is initially input data, generate a predetermined additional area in the main table 121 when the data is initially input data, and store position information extracted from the data in an additional area of the main table 121. When the data is not initially input data, the server 100 may store the position information extracted from the data in a designated area of the main table 121, which is allocated to a recipient of the data.

In another embodiment, the server 100 may sort the main table 121 and/or the sub-table 122 in consideration of a receiving order or a receiving terminal's position. In this case, the server 100 may allocate records included in the main table 121 in an order in which the records were received. The server 100 may determine whether data received when a transaction is performed is initially input data, generate a predetermined additional area in the main table 121 when the data is initially input data, and store position information extracted from the data in an additional area of the main table 121. When the data is not initially input data, the server 100 may store the location information extracted from the data in a designated area of the main table 121, which is allocated to an order in which the data was received or a position of a terminal that has received the data.

The data transmitter 123 may perform a function to create the sub-table 122. Also, the data transmitter 123 may use a result of analyzing data stored in the main table 121 or the sub-table 122 to convert the data into a packet and transmit the packet to the external database. For example, the data transmitter 123 may determine meaningful data from the collected information, process the data, and transmit the processed data to the external database.

A criterion for determining the meaningful data may be set by a user and may be set corresponding to a position change. For example, data for a terminal whose geographical position is fixed may be removed even though collected, and data for a terminal whose geographical position is detected to be changed may be transmitted to the external database. In particular, meaningful data may be processed and then transmitted. For example, the data transmitter 123 may process data to generate a packet such that the packet further includes information regarding a period of time for which the packet had stayed at a corresponding position. That is, the packet may be generated such that the packet includes information regarding an initial time and a final time between which the packet had stayed at the corresponding position (e.g., from a first time to a second time). Also, the packet may include information regarding one or more terminals positioned together at the corresponding position (e.g., a first terminal, a second terminal, and a third terminal at a first point). Also, the packet may include information regarding a position change (e.g., from a second point to a third point at a third time point).

The external database may generate the received packet as a separate independent record. The external database may store and manage the generated record. The external database may also read the received packet to store and manage the processed data. The processed data may be generated on the basis of user, position, time, and route.

The data transmitter 123 may read the data stored in the main table to determine whether the position information acquired from the data is different from position information previously received. The previous position information may be stored in the sub-table 122.

The data transmitter 123 may read the data stored in the main table 121. When the acquired position information is different from the previous position information, the data transmitter 123 may move the data to the sub-table and convert the data stored in the sub-table 122 into a packet.

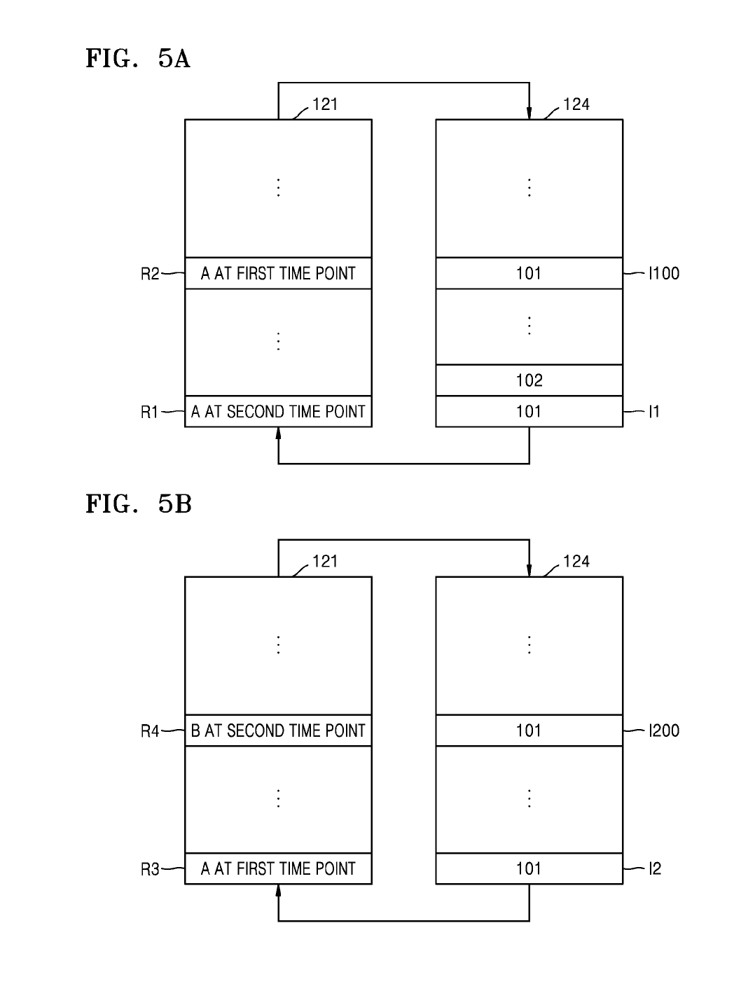

The data transmitter 123 may also determine whether there is duplication in the data stored in the main table 121. Duplicated data may be continuously removed. A size of the main table 121 may be optimized. A method of searching for duplicated data will be described with reference to FIGS. 5A and 5B.

The data transmitter 123 may correct the log data. In this case, the data transmitter 123 may utilize information regarding peripheral devices included in the log data. The data transmitter 123 may read the data stored in the main table 121. When the position information acquired from the data does not satisfy a predetermined condition, the data transmitter 123 may additionally search for peripheral information corresponding to the data. The data transmitter 123 may correct the position information using the peripheral information. Preferably, when the acquired position information is farther than a threshold distance (e.g., 1 km) from previous position information, it may be determined that the positional movement is physically impossible. The data transmitter 123 may correct the position information using peripheral device information included in the log data. Here, the peripheral device information may refer to a device connected by short-distance communication (e.g., Bluetooth, RF, etc.) and may include an identifier assigned to the connected device. In another embodiment, the peripheral device information may refer to an apparatus (e.g., a base station) connected by mobile communication and may include an identifier assigned to the connected device. Preferably, when country information corresponding to the acquired position information is different from country information corresponding to previous position information, the data transmitter 123 may correct the position information using the peripheral device information included in the log data. Also, the server 100 may acquire the information regarding peripheral devices through a separate process. Also, the server 100 may acquire the information regarding peripheral devices while directly communicating with the peripheral devices. The acquired information regarding peripheral devices may be processed through a process of searching for a user terminal adjacent to the peripheral devices.

Thus, the server 100 according to embodiments of the present invention may reduce resources needed for data storage and management since data determined as meaningless data is not stored even though the log data is received in real time. The server 100 according to embodiments of the present invention may generate a position change history of a plurality of terminals using a smaller amount of data by transmitting a packet to the external database only when a position change is detected. The server 100 according to embodiments of the present invention may protect log data stored in different divided areas since the log data is divisionally stored in a predetermined amount of units. Divisional storage refers to storage divisionally performed in areas that are set such that they do not affect each other. Accordingly, even when a first area is hacked or damaged, data stored in a second area may be safely protected.

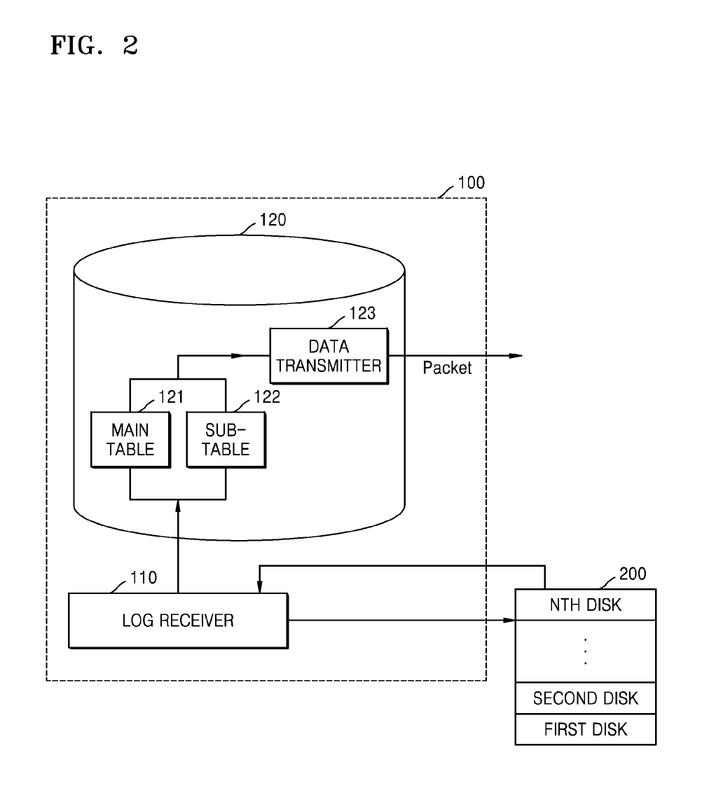

FIG. 2 is a diagram for describing an operation associated with the log receiver 110 according to embodiments of the present invention.

Referring to FIG. 2, the log receiver 110 may be electrically connected to an external storage or recording medium 200. A memory shortage problem can be solved by receiving the log data at a higher rate than when data is transmitted to an external database by the data transmitter 123. For example, when the log receiver 110 stores and manages the log data in order of reception and a predetermined amount of the data is exceeded, the log receiver 110 may store a set of log data received up to now in the separate recording medium 200. In this case, the set of log data may be stored in one area that is independently allocated or divided. The set of log data may be stored in order of reception. For example, a first set of log data is stored in a first disc, and a second set of log data is stored in a second disc. The first set of log data may be moved to the main table 121 or the sub-table 122 or may be transmitted to an external database by the data transmitter 123, and the corresponding log data may be deleted. In this case, the first set of log data may affect only an area in which the first set is stored. That is, the first set may be removed without affecting second to nth discs. The amount of data that is included in each set and stored in each disc may be the same.

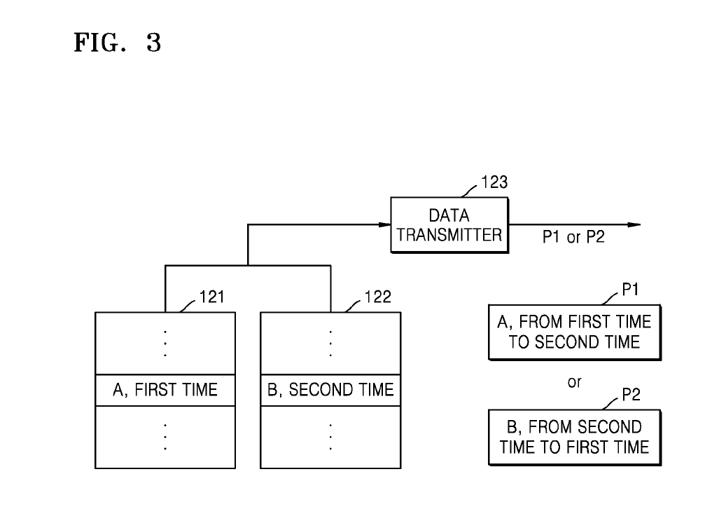

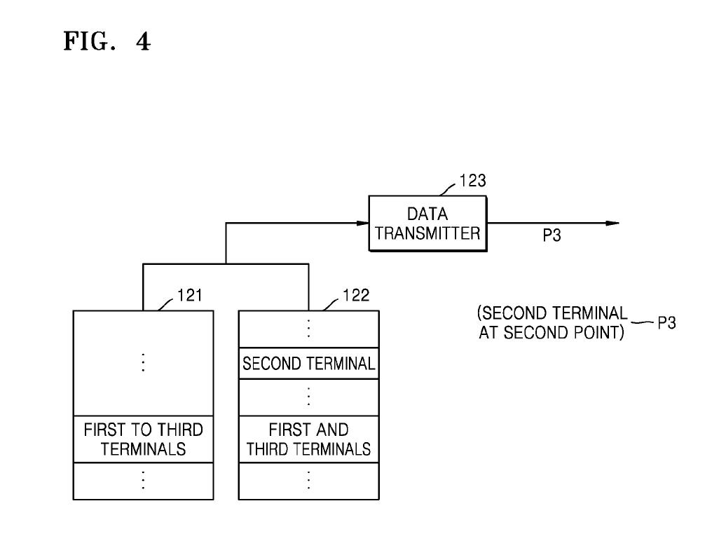

FIGS. 3 and 4 are diagrams for describing examples of packets generated by the data transmitter 123.

The server 100 may generate a packet using the main table 121 and the sub-table 122 that are sorted for each user. In this case, the main table 121 and the sub-table 122 may store position information of a first user in the same position area. As shown in FIG. 3, the main table 121 may store (A, first time) as the position information of the first user, and the sub-table 122 may store (B, second time) as position information of a second user. In this case, the data transmitter 123 may generate a first packet P1 (A, from the first time to the second time) corresponding to a position change of the first user in order of storage in the main table 121 and the sub-table 122. When data is first stored in the sub-table, the data transmitter 123 may generate a second packet P2 (B, from the second time to the first time) corresponding to the position change of the first user.

In another embodiment, the server 100 may generate a packet using the main table 121 and the sub-table 122 that are sorted for each position. As shown in FIG. 4, first to third terminals may be positioned at a first point according to the main table 121. According to the sub-table 122, the first terminal and the third terminal may be positioned at the first point, and the second terminal may be positioned at a second point. When only the position of the second terminal changes according to the main table and the sub-table, the data transmitter 123 may generate a third packet P3 (the second terminal at the second point) corresponding to a position change of the second terminal. The third packet may be transmitted to an external database.

FIGS. 5A and 5B are diagrams for describing a process of determining whether there is duplication in a main table.

The server 100 may use an index table 124 to determine whether there is duplication in the main table 121. First, the server 100 sequentially reads the index table 124. In this case, when data that is the same as the read data is found, the data may be determined as redundant. As shown in FIG. 5A, when it is determined that a first index I1 is the same as a hundredth index I100, the server 100 reads records R1 and R2 stored at positions corresponding thereto. In this case, the server 100 may read a first record R1 and a second record R2 to determine which record will be removed. When the server 100 includes the same position information, the server 100 compares a second time point included in the first record R1 and a first time point included in the second record R2 to leave only a record corresponding to a previous time point and delete the other record. That is, when the first time point is earlier than the second time point, the server 100 may leave the second record R2 and delete the first record R1. When the second time point is earlier than the first time point, the server 100 may leave the first record R1 and delete the second record R2. Thus, only records that may be interpreted in a comprehensive manner are left.

As shown in FIG. 5B, when it is determined that a second index I2 is the same as a two-hundredth index I200, the server 100 reads records R3 and R4 stored at positions corresponding thereto. In this case, the server 100 may read a third record R3 and a fourth record R4 to determine which record will be removed. When the third record R3 and the fourth record R4 are determined not to have the same position information, the server 100 compares a first time point included in the third record R3 and a second time point included in the fourth record R4 to leave only a record corresponding to a subsequent time point and delete the other record. That is, when the first time point is later than the second time point, the server 100 may leave the third record R3 and delete the fourth record R4. When the second time point is later than the first time point, the server 100 may leave the fourth record R4 and delete the third record R3.

The server and method for managing a position change according to embodiments of the present invention may reduce resources since data determined as meaningless data is not stored even though log data is received in real time.

Also, the server and method for managing a position change according to embodiments of the present invention may generate a position change history of a plurality of terminals using a smaller amount of data since a packet is transmitted to the external database only when the position change is detected.

Also, the server and method for managing a position change according to embodiments of the present invention may protect log data stored in different divided areas since the log data is divisionally stored in a predetermined amount of units.

The above-described embodiments of the present invention may be implemented in the form of a program instruction that is executable through various computer components and recordable on a computer-readable recording medium. Examples of the computer-readable recording medium may include a magnetic medium such as a hard disk, a floppy disk, or a magnetic tape, an optical medium such as a compact disc-read only memory (CD-ROM) or a digital versatile disc (DVD), a magneto-optical medium such as a floptical disk, and a hardware device such as a ROM, a RAM, or a flash memory that is specially designed to store and execute program instructions.

The computer program may be designed and configured specifically for the exemplary embodiments or may be known and available to those skilled in computer software. Examples of the computer program include a high-level language code executable by a computer with an interpreter, in addition to a machine language code made by a compiler.

The particular implementations shown and described herein are illustrative examples of this disclosure and are not intended to otherwise limit the scope of this disclosure in any way. For the sake of brevity, conventional electronics, control systems, software development and other functional aspects of the systems may not be described in detail. Furthermore, the connecting lines or connectors shown in the various figures presented are intended to represent exemplary functional relationships and/or physical or logical couplings between the various elements. It should be noted that many alternative or additional functional relationships, physical connections or logical connections may be present in an actual device. Moreover, no item or component is essential to the practice of this disclosure unless the element is specifically described as “essential” or “critical.”

The use of the terms “a,” “an,” “the,” and similar referents in the context of describing the embodiments (especially in the context of the following claims) are to be construed as covering both the singular and the plural. Furthermore, recitation of ranges of values herein are merely intended to serve as a shorthand method of referring individually to each separate value falling within the range unless otherwise indicated herein, and each separate value is incorporated into the specification as if it were individually recited herein. Finally, the steps of all methods described herein can be performed in any suitable order unless otherwise indicated herein or otherwise clearly contradicted by context. The present disclosure is not limited to the described order of the steps. The use of any and all examples or exemplary language (e.g., “such as” or “for example”) provided herein is simply intended to better illuminate this disclosure and does not pose a limitation on the scope of the appended claims unless otherwise claimed. Numerous modifications and adaptations will be readily apparent to those skilled in this art without departing from the spirit and scope of the present disclosure.

What is claimed is:

1. A server for managing a position change in real time, the server comprising:
a log receiver configured to store log data in order of reception;
a main table configured to sort and store the log data using a certain sorting method;
a sub-table configured to temporarily store the log data; and
a data transmitter configured to sequentially read and process a log stored in the main table or the sub-table in real time and transmit the log to a remote database in real time, wherein:
the server determines whether data received when a transaction is performed is initially input data, stores position information extracted from the data in a predetermined additional area of the main table when the data is the initially input data, and stores the position information extracted from the data in a designated area allocated to a recipient of the data when the data is not the initially input data; and
the data transmitter analyzes the data stored in the main table, converts the data into a packet using a result of the analysis, and transmits the packet.

2. The server of claim 1, wherein the data transmitter reads data stored in the main table and determines whether the position information extracted from the data is different from previous position information.

3. The server of claim 2, wherein the data transmitter reads the data stored in the main table, and moves the data to the sub-table and converts data stored in the sub-table into a packet only when the extracted position information is different from the previous position information.

4. The server of claim 3, wherein the data transmitter determines whether there is duplication in the data stored in the main table and removes duplicated data.

5. The server of claim 1, wherein the data transmitter reads data stored in the main table, and additionally searches for peripheral information corresponding to the data and corrects the position information using the peripheral information when the position information extracted from the data does not satisfy a predetermined condition.

6. The server of claim 1, wherein the data transmitter analyzes the data to acquire a start time point and an end time point, generates a header including (from the start time point, to the end time point), and generates a packet by adding the header to the data.

7. A method of managing a position change in real time, the method comprising:
storing, by a log receiver, log data in order of reception;
sorting and storing, by a server, the log data in a main table using a certain sorting method;
determining whether data received when a transaction is performed is initially input data and storing position information extracted from the data in a predetermined additional area of the main table when the data is the initially input data; and
sequentially reading and processing, by a data transmitter, a log stored in the main table or the sub-table and transmitting the log to a remote database in real time.

8. The method of claim 7, wherein the transmitting comprises using, by the data transmitter, a result of analyzing the data stored in the main table to convert the data into a packet and transmit the packet.

9. The method of claim 8, wherein the transmitting further comprises reading, by the data transmitter, the data stored in the main table and determining whether the position information extracted from the data is different from previous position information.

10. The method of claim 9, wherein the transmitting further comprises reading the data stored in the main table, and moving the data to the sub-table and converting data stored in the sub-table into a packet only when the acquired position information is different from the previous position information.

11. The method of claim 9, wherein the transmitting comprises determining whether there is duplication in the data stored in the main table and removing duplicated data.

12. The method of claim 9, wherein the transmitting further comprises reading the data stored in the main table, and additionally searching for peripheral information corresponding to the data and correcting the position information using the peripheral information when the position information extracted from the data does not satisfy a predetermined condition.

13. The method of claim 7, wherein the transmitting comprises analyzing the data to acquire a start time point and an end time point, generating a header including (from the start time point, to the end time point), and generating a packet by adding the header to the data.
